(19) United States
(12) Patent Application Publication
(10) Pub. No.: US 2006/0022484 A1
(43) Pub. Date: Feb. 2, 2006

(54) Integrated vehicle sunshade

(76) Inventor: Wang Su, East Patchogue, NY (US)

Correspondence Address: Wang Su, 154 Donegan Ave., East Patchogue, NY, 11772, US

(21) Appl. No.: 10/899,578

(22) Filed: Jul. 27, 2004

(51) Int. Cl. B60J 1/20

(52) U.S. Cl. 296/138

(57) ABSTRACT

An integrated vehicle sunshade for saving vehicle interior space having a hinge adapted to be installed inside an enclosure of a vehicle such as inside a window frame, and a blocking material which folds substantially inside the enclosure when it is in a folded position.

### FIELD OF INVENTION

The present invention is generally related to the automobile industry and, in particular, to an integrated sunshade used on an auto vehicle.

### BACKGROUND OF THE INVENTION

Auto vehicles are often exposed to outside environment for lengthy period of times. If a vehicle is parked in a sunny place with the windows closed, the heat generated by sunlight will accumulate inside the vehicle and cause unwelcoming effects, such as making passengers feel very uncomfortable or damaging electronic equipments installed in the vehicle.

Various attempts have been made to alleviate this problem. One of such attempts is to use sunshades. Sunshades are often made of semi-reflective foldable material to be placed next to vehicle windows to block sunlight. One major drawback of the current sunshades is that, even though a lot of them are foldable, they still take considerable space in the vehicle. Unlike in a large house where space is often not a critical issue, the interior space of an auto vehicle is quite limited, therefore even the space taken by a folded sunshade is significant, especially when the vehicle is full of passengers. This may contribute to the fact that a lot of people would rather expose their vehicles under the sunlight than to put a foldable sunshade in their cars.

This invention solves the problem by presenting an integrated sunshade which utilizes space not normally useable by current foldable sunshades. This design is un-intrusive to the passengers and easy to use, therefore presents a significant advantage over traditional foldable sunshades.

### SUMMARY OF THE INVENTION

This invention presents a sunshade that is integrated into an auto vehicle, not simply attached to a surface of an auto vehicle. The integrated sunshade may have two positions, for example an extended position and a folded position. When it is in the folded position, it folds substantially into a space in the vehicle which is generally not accessible by the passenger, such as inside a window frame. The invention is explained in detail below.

### BRIEF DESCRIPTION OF THE DRAWING

FIG. 1 is a front view of an embodiment of an integrated vehicle sunshade.

### DETAILED DESCRIPTION OF THE DEARWING AND POSSIBLE EMBODIMENTS OF THE INVENTION

Possible embodiments of the invention are discussed in this section.

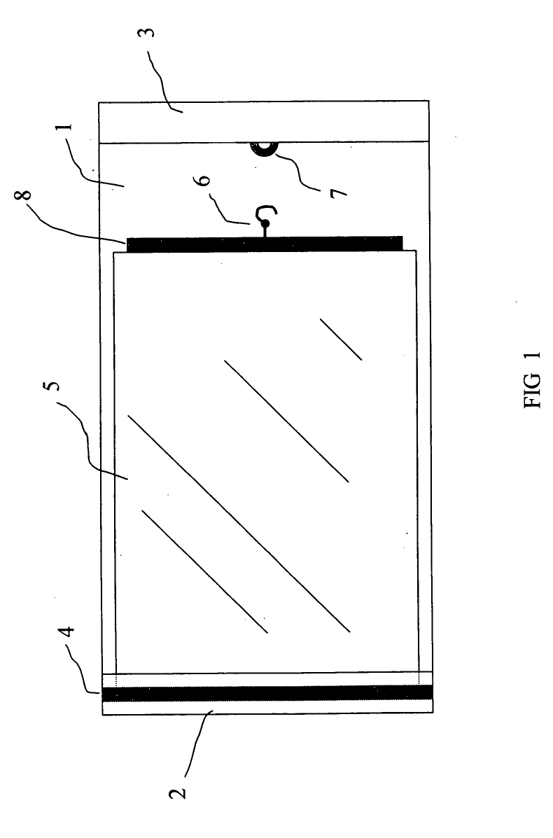

Auto vehicles often have frames surrounding their windows, either front window, rear window, or side window. At least some of these window frames often enclose a space within. These enclosed paces of auto vehicle window frames are often not utilized. According to one embodiment of the invention as shown in FIG. 1, a window 1 of an auto vehicle may have at least two window frames 2 and 3, at least one of them enclose a space, for example the space as shown within frame 2. Window frames 2 and 3 may be made of metal or synthetic materials such as plastic, or the combination of metal and synthetic materials.

A hinge 4 is installed inside the space enclosed within window frame 2. The hinge 4 may be attached to the vehicle in a way that the hinge 4 is turnable. A spring means, which is not shown in the figure, is attached to the hinge 4 in a way that biases the hinge 4 towards a starting position. If the hinge 4 turns away from the starting position, the spring means may produce a force that tends to bias the hinge back to the starting position. The spring means may be a spring, a permanent magnet, or a magnetic coil that products a magnetic force in an electromagnetic filed.

A blocking material 5 may be attached to hinge 4. The blocking material 5 may be foldable and semi-reflective. When extended across the window 1, the blocking material 5 blocks at least part of the sunlight that would otherwise pass through the window 1. When in a folded position, the blocking material 5 may folds around the hinge 4 inside the window frame 2. Only a small portion of blocking material 5 may extend outside of window frame 2 when it is in the folded position.

An attaching means 6 may be attached to the blocking material 5. The attaching means 6 may be a hook, a piece of magnet, a vacuum suction cup, or a fastening tape such as the kind produced by Velcro Industries B.V. There may also be a receiving means 7 attached to an opposing window frame 3. The receiving means 7 is designed to receive the attaching means 6 as is needed. The receiving means 7 may be a half ring, a piece of magnet, or a fastening tape. In some situations, for example when the attaching means is a vacuum suction up, there is no need for a receiving means 7, because the attaching means 6 may be attaching directly to window frame 3.

According to another embodiment of the invention, the hinge 4 is rigidly attached to the vehicle and there is no spring means attached to the hinge 4. At least part of the blocking material 5 comprises an expandable material such as elastic rubber. The expandable material may expand when a force is applied to it to allow the blocking material 5 to be in an expanded position, it may then contract when the pulling force goes away to pull the blocking material 5 back in a folded position. When the blocking material is in the expanded position, the pulling force is maintained by attaching the attaching means 6 to the window frame 3 either directly or via a receiving means 7.

According to another embodiment of the invention, the hinge 4 is rigidly attached to the vehicle. The blocking material 5 may be folded substantially inside of window frame 2 or extended across much of window 1. One end of the blocking material 5 is attached to the hinge 4. The other end of the blocking material 5 has a further attaching means 8 which may be attached to window frame 2 when the blocking material 5 is in a folded position. The attaching means 8 may be a hook, a piece of magnet, a vacuum suction cup, or a fastening tape. The attaching means 8 may be the same attaching means as the attaching means 6.

According to another embodiment of the invention, the hinge 4 may be attached to the vehicle in a position which is on top of the window 1, such as inside an upper frame of the window 1 or the ceiling. The receiving means 7 may be attached to a position which is at the bottom of the window 1 such as a lower window frame or the dash board.

According to another embodiment of the invention, the hinge 4 is attached to a position which is at the bottom of the window 1, such as inside a lower window frame or the dash board. The receiving means 7 may be attached to a position which is on top of the window 1, such as an upper frame of the window 1 or the ceiling.

It is obvious that there are numerous different variations and combinations of the above described embodiments of the invention. All these different variations, combinations and their equivalences are foreseen and considered as part of the invention. The invention is further defined and claimed by the following claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An improved vehicle with an integrated sunshade comprising a vehicle body having at least a window frame which encloses a space, a hinge, and a blocking material, wherein the hinge is at least partially placed inside the space enclosed by the window frame, and wherein the blocking material is connected to the hinge at one end and is movable at another end.

15. The improved vehicle of claim 14 wherein the blocking material folds substantially inside of the space when it is in a folded position.

16. The improved vehicle of claim 15 wherein the window frame is made of metal or synthetic materials.

17. The improved vehicle of claim 14 further comprising at least one spring means connected to the hinge to bias the hinge towards a starting position.

18. The improved vehicle of claim 17 further comprising at least one attaching means attached to the blocking material for attaching the blocking material to the vehicle body.

19. The improved vehicle of claim 14 wherein the blocking material is extendable and foldable.

20. The improved vehicle of claim 19 further comprising at least one attaching means attached to the blocking material for attaching the blocking material to the vehicle body.
